(19) United States
(12) Patent Application Publication
(10) Pub. No.: US 2007/0098542 A1
(43) Pub. Date: May 3, 2007

(54) ROTATIONAL POWER SYSTEM

(76) Inventors: Foy Streeman, Chickasha, OK (US); R. Willam Graham, Springboro, OH (US); Benjamin C. Stone, Dayton, OH (US)

Correspondence Address: R. William Graham, 22 S. St. Clair St., Dayton, OH, 45402, US

(21) Appl. No.: 11/551,795

(22) Filed: Oct. 23, 2006

Related U.S. Application Data
(60) Provisional application No. 60/731,916, filed on Oct. 31, 2005.

(51) Int. Cl. F03D 7/06

(52) U.S. Cl. 415/4.2

(57) ABSTRACT

A rotational power transfer device includes a rotatable shaft, a plurality of arm structures attached to the shaft and extending radially outward from the shaft, a plurality of panel members attached to the arm structures and hanging downward therefrom, and an energy converting member for converting energy to electricity. Another vertical turbine is includes a rotatably driven power maker using panel members connected to a drive shaft such that the panel members are laterally disposed from the drive shaft in a spaced relation therefrom. A wind power generation system includes a turbine and roof top wind collector.

This application claims the benefit of provisional U.S. application 60/731,916 filed Ser. No. 10/31/2005.

### BACKGROUND OF THE INVENTION

1. Field of the Invention

The present invention relates to the field of natural energy. More particularly, the invention relates to devices for producing power from wind or water.

2. Prior Art

Commonly owned U.S. Pat. No. 6,537,018 describes a rotational power transfer device which operates without requiring orientation of the device to face an existing prevailing wind current and which is safely operably disposable in severe wind conditions. This improvement over other described types of natural energy driven devices such as windmills includes a plurality of blades or foils and operate on a principle by which air current forces rotation of the blades when properly disposed into the wind current.

This prior invention focused on the fact that the device did not have to be directed into the wind current in order to operate. Some windmills have utilized tails in order to orient the blades into the wind current. However, these designs require a relatively significant amount of wind in order to achieve proper orientation and operation. Wind turbine machines of various designs have been proposed for use in converting wind energy to electrical energy. Machines of the type utilizing a plurality of exposed blades rotating about a horizontal axis are in commercial use in a number of different locations. Many such designs lack sufficient integrity under heavy wind conditions.

Also, prior wind turbines typically utilize a rotor which is rotatable about a vertical axis. The rotor normally includes a plurality of blades. Also, pluralities of stationary wind deflectors or wind-directing blades have been used around the rotor to deflect air toward the rotor blades. The typical wind deflectors are generally planar or slightly curved devices which are vertically oriented and are positioned around the perimeter of the rotor.

Inventor's recent advancements in the technology improve the manner in which wind and other natural motion forces are harvested as a natural resource. It is desired that there be a rotational power transfer device which provides greater torque output and which is safely operably disposable in severe wind conditions. Accordingly, the present invention provides such a system.

### BRIEF SUMMARY OF THE INVENTION

It is an object of the present invention to provide an improved novel energy producing device.

It is another object of the invention to provide an energy producing device which has a power output which is greater than the prior art wind turbine devices.

It is yet another object of the invention to provide a novel energy producing device which is operable in any environment where natural motion exists.

Accordingly, the present invention is directed to a rotational power transfer device which meets these objectives.

The present invention is directed to a rotational power transfer device which includes a shaft and an annular member concentrically fixed about a drive shaft, wherein a set of arms are positioned spatially positioned outward from the annular member in a manner to maintain balance during rotation, particularly at high speeds. In a preferred aspect of the invention, the center-rotating shaft is oriented in a vertical position and the outwardly extending arms are positioned 90 degrees in a perpendicular relationship with respect to the drive shaft.

Each of the outwardly extending arms further includes a pivotally connected lightweight flap-like material or panel member hanging downwardly therefrom so that they are able to swing freely in one direction upon exertion of pressure. A set of pins extends outwardly from the annular member. The number of pins is equal to the number of arms and such pins are oriented a distance from a corresponding arm such that the panel member hanging downwardly from each arm rests against the corresponding pin and prevents movement of the panel member when confronting pressure in one direction and permits swinging movement of the panel movement member when confronting pressure in an opposite direction.

Additionally, a partial enclosure can be provided about the annular member, arms, pins and panel members and be reciprocally connected to the shaft. The enclosure includes a venturi inlet and an outlet to accelerate the speed of the fluid flow into the enclosure and adjacent the panel members. A tail fin can be connected to the enclosure to direct the venture inlet into the fluid flow.

The moving parts of the rotational power transfer device of this invention are the panel members, enclosure and the rotating shaft. The shaft moves in relation to what the design mechanics dictate, and is based on the pins being on the same side of the panel members to prevent at least one of the panel members from swinging upward when subjected to a force delivered by wind or other natural or unnatural motion. Natural motion is intended to include winds, breezes, currents, tides, gravity, magnetic forces, etc. Unnatural motion is intended to include motions subject to influence by man, such as the flow of fluids and gases through pipes, from a reservoir, or the like. For example, expanding gas as it is being produced from a gas well is a potential generator to power the rotational power transfer device of the invention.

In response to the force of the fluid movement through a prevailing path of the inlet to the outlet, the motion the panel members facing such force are prevented from swinging upward, whereas the panel members which move in a direction opposite the prevailing path swings freely because the pin corresponding to the panel member is on the same side of the panel member as the prevailing force. The rotational power transfer device will respond to any motion present in precisely the same way whether the motion force is wind, fluid flow, gravity, magnetic forces, or other such forces.

The direction of the wind is immaterial because the device will always be directed to have at least one side where the pin catches the panel member to retain it in a vertical position and, therefore will always transfer the energy to the rotating shaft, while the panel member of the opposite side of the device does not resist the wind force and, accordingly, is free to swing upward in response to the motion force where it becomes oriented in the motion force direction. As the rotational shaft rotates on its axis, each of the panel members in a sequential manner is caught by its corresponding pin causing the motion to apply a rotating force thereon. The rotating shaft can be directly connected to, or attached, by power transfer devices, to a compressor, generator, or other form of energy converting devices for further use.

Accordingly, the invention is directed to a rotational power transfer device. The device includes a rotatable drive shaft having a first end and a second end. An annular member is concentrically connected to the drive shaft.

A set of arms are positioned spatially positioned outward from the annular member in a manner to maintain balance during rotation, particularly at high speeds. In a preferred aspect of the invention, the center-rotating drive shaft is oriented in a vertical position and the outwardly extending arms are positioned 90 degrees in a perpendicular relationship with respect to the drive shaft.

Each of the outwardly extending arms further includes a pivotally connected lightweight panel member hanging downwardly therefrom so that each is able to swing freely in one direction upon exertion of pressure. A set of pins extends outwardly from the annular member. The number of pins is equal to the number of arms and such pins are oriented a distance from a corresponding arm such that the panel member hanging downwardly from each arm rests against the corresponding pin and prevents movement of the panel member when confronting force in one direction and permits swinging movement of the panel movement member when confronting pressure in an opposite direction.

A housing is provided about the annular member, panel members, arms and pins, and has an inlet and an outlet, wherein the inlet and outlet are configured to form a path to receive fluid flow through the housing. The shaft is operably disposed in a position transverse to the path having the first end rotatably connected to the housing and a second end rotatably connected to the housing and a remainder of the housing substantially containing the fluid path about the shaft.

The inlet and outlet can be formed to provide a venture effect within the housing. A screen can be connected to the inlet and configured to prevent debris from entering without substantially affecting fluid flow thereby. An energy converter can be attached to the shaft of the device for converting energy provided thereby to electricity.

Another aspect of the present invention is directed to a vertical turbine which aims to meet the aforesaid objectives. The vertical turbine includes a rotatably driven electric generator or air compressor, a drive shaft operably connected to the electric generator or air compressor, hydraulic pump, or other form of energy converting devices for further use, a first member preferably having an arcuate surface and being connected to the shaft such that the member is laterally disposed from the drive shaft in a spaced relation therefrom, a second member preferably having an arcuate surface and being connected to the shaft such that the cavity surface is laterally disposed from the drive shaft in a spaced relation therefrom, and wherein the arcuate surfaces are further characterized to be in partially overlapping relation to one another. Suspending supports are provided for the first member and the second member in a manner which permits freedom of movement between an operable and inoperable position by virtue of forces of air current directed at the members. The first and second members can be, for example, elongated blades which are slightly arcuate.

Still another embodiment of the invention is directed to a wind powered energy generation system. The system includes a roof top of a building, a turbine having a rotatably driven power maker, a drive shaft operably connected to the power maker and generally horizontally disposed with respect to the roof top, a first panel member connected to the shaft such that the first panel member is laterally disposed from the drive shaft in a fixed spaced relation therefrom, a second panel member connected to the shaft such that the second panel member is laterally disposed from the drive shaft in a fixed spaced relation therefrom, wherein the panel members rotate about the shaft without interference with the roof top and a shroud extending partially about the panel members and connected to a tail which turns the shroud into a prevailing wind so that the shroud covers at least a portion of the panel members which, but for the shroud, would fight prevailing wind during rotation.

Further, the drive shaft is interconnected to the members to permit a degree of freedom of movement in a normally vertically disposed position. The drive shaft can be hinged to pivot the turbine in extreme conditions. The members rotate about the normally vertically disposed drive shaft (with respect to the ground). A shroud extends partially about the members and is connected to a tail which turns the shroud into a prevailing wind so that the shroud covers at least a portion of the blade members which but for the shroud would fight the prevailing wind upon rotation.

Other objects and advantages will be readily apparent to those persons skilled in the art upon viewing the drawings and reading the detailed description.

### BRIEF DESCRIPTION OF THE DRAWINGS

FIG. 1 is a perspective view of a rotational power transfer device of the invention;

FIG. 2 is another perspective view of the rotational power transfer device of the invention illustrating fluid flow therethrough;

FIG. 3 is a top of the rotational power transfer device of the invention;

FIG. 4A is a perspective view of the rotational power transfer device of the invention;

FIG. 4B is a perspective view of another embodiment the rotational power transfer device of the invention;

FIG. 5 is a top view of another embodiment depicting the operating principle of the present invention.

FIG. 6 is a right side view the present invention depicted in FIG. 5.

FIG. 7 is a front view the present invention depicted in FIG. 5.

FIG. 8 is a left side view the present invention depicted in FIG. 5.

FIG. 9 is a side another embodiment of the invention.

FIG. 10 is a front view of the embodiment of FIG. 9.

### DETAILED DESCRIPTION OF THE INVENTION

For the purpose of this invention, the term “wind” is generally used to describe the motion force applied to the device unless otherwise stated. However, it will be recognized that any form of motion force, natural or unnatural may be utilized to power the device.

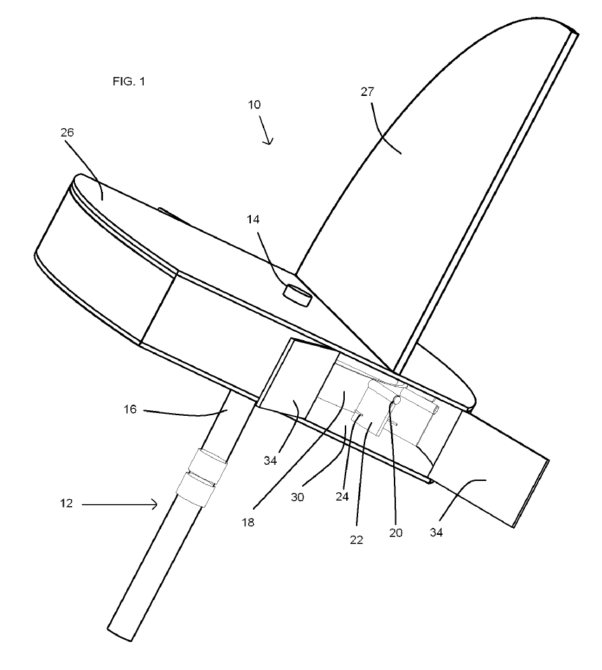

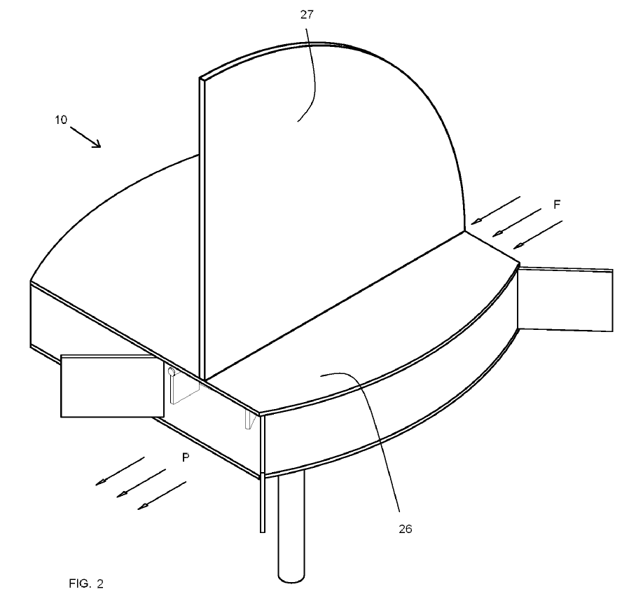

Referring now to the drawings, one embodiment of a rotational power transfer device 10 of the present invention is shown in FIGS. 1-4 which illustrate an embodiment of the present invention. The rotational power transfer device 10 described herein is shown here as comprising a vertically disposed rotatable drive shaft 12 having a first end 14 and a second end 16. An annular member 18 is concentrically connected to the drive shaft 12 by way of radial supports 13.

A set of arms 20 are positioned spatially positioned outward from the annular member 18 extend outwardly in a horizontal plane wherein the arms are equidistance apart in a manner to maintain balance during rotation, particularly at high speeds. The center-rotating drive shaft 12 is oriented in a vertical position and the outwardly extending arms 20 are positioned generally 90 degrees in a perpendicular relationship with respect to the drive shaft 12.

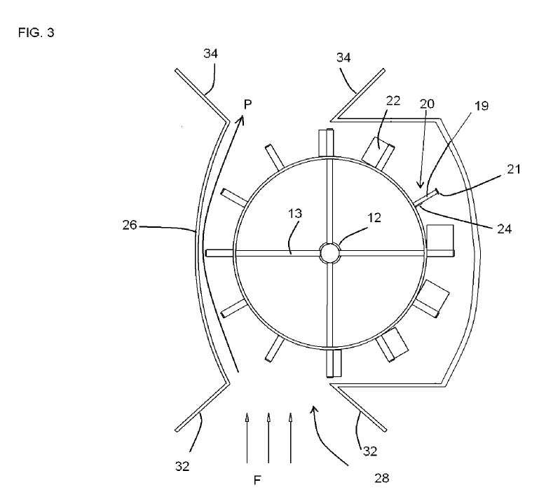

Each of the outwardly extending arms 20 further includes a pivotally connected lightweight panel member 22 hanging downwardly therefrom so that each is able to swing freely in one direction upon exertion of pressure. A set of pins 24 extends outwardly from the annular member. The number of pins 24 can be equal to the number of arms 22 and such pins 24 are oriented a distance from a corresponding arm 18 such that the panel member 22 hanging downwardly from each arm 20 rests against the corresponding pin 24 and prevents movement of the panel member 22 when confronting force in one direction as seen ins FIGS. 1-4 and permits swinging movement of the panel member 22 when confronting pressure in an opposite direction as seen in FIG. 3.

A housing 26 is provided about the annular member 18, panel members 22, arms 20 and pins 24, and has an inlet 28 and an outlet 30. The inlet 28 is configured by two opposing converging wall portions 32 and the outlet 30 is configured by two opposing diverging wall portions 34. The inlet 28 and outlet 30 provide a venturi effect and form a fluid flow path P through the housing 26.

The drive shaft 12 is operably disposed in a position transverse to the path P having the first end 14 and second end 16 rotatably connected to the housing 26. The housing 26 can be configured with a fin 27 to aid in directing the inlet 26 into the prevailing fluid flow F. The housing 26 can include openings 29 to aid in permitting eddy current flow to exit therefrom.

Any number of sets of arms 20, panel members 22 and pins 24 (one set includes one arm, one corresponding panel member and one corresponding pin) may be employed. For the purpose of illustration, the device is shown as having twelve sets of arms 20, panel members 22 and pins 24 connected to the annular ring 18. Each arm 20 has a corresponding panel member 22 longitudinally attached. Typically, the arms 20, panel members 22 and pins 24 can be constructed from a rigid plastic or lightweight metal, e.g., aluminum. In some instances where the motion force is a strong current or wind, the arms, pins and panel members may be constructed of a more substantial material which can withstand the strong current or wind. For example, if the device 10 is used in a pipeline or in a river where the flow of fluid provides a substantial force on the device, heavier materials may be employed. In addition, the panel member 22 may have a plurality of reinforcement ridges (not shown) running parallel to the shaft in order to prevent the panel member 22 from buckling. To add further strength to the device, a thin circular outer ring 36 (FIG. 3) may be used to connect the outer ends of the arms 20 together. This would reduce the chance of the arms 20 bending or being displaced by surges in the motion force without requiring the arm structures to be made of heavy materials.

The panel members 22 are securely connected to the respective arms 20. For example, the panel members 22 can include a tubular end 23 through which a smaller elongated portion 19 of the arm 20 extends, wherein the arm 20 can have an enlarged end 21 to retain the tubular end 23, this providing a hinged mechanism. Other attachments can be employed which would allow the panel member 22 to swing freely from the corresponding arm 20. The panel members 22 are spaced apart a short distance from the annular member 18 to prevent any contact between the panel member 22 and the annular member 18.

The pins 24 protrude outwardly from the annular member 18 in a generally perpendicular or normal manner to the annular member 18. The number of pins 24 present on the shaft is equal to the number of arms 20 present. The pins 24 are vertically offset with the corresponding arms 20 and can have an approximate length equal to that of the arms 20. In accordance with the invention, each pin 24 is located on the annular member 18 at a predetermined distance from the corresponding arm 20 so that each panel member 22 rests against a corresponding pin 24 when facing pressure exerted in the path P.

For example, this arrangement allows the panel members 22 to act as sails and catch the wind cause rotation while panel members 22 outside the path P are free to swing in the direction of the wind. Pins 24 are all on the same side of the respective panel members 22.

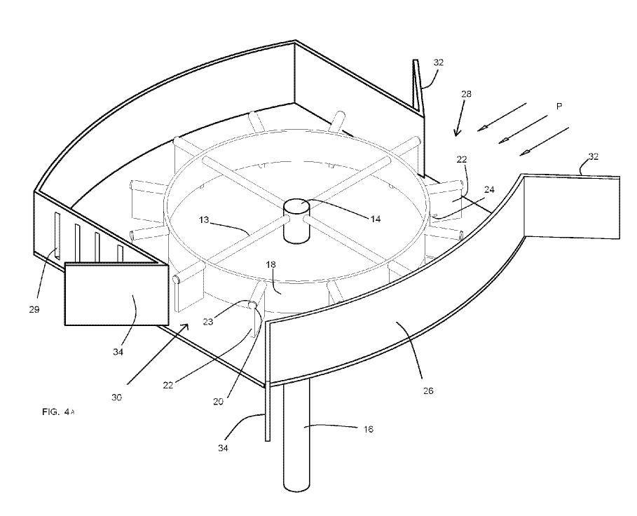

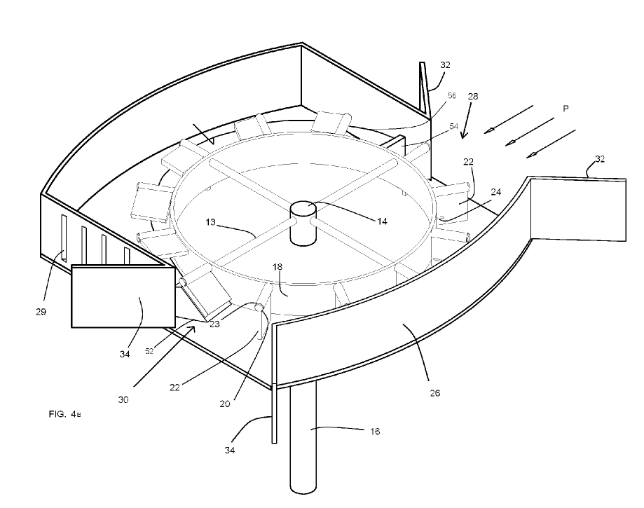

The embodiment of FIG. 4B shows the addition of blocks 52 and 54 to prevent fluid flow from entering the area outside path P. Also, block 52 can be wedge shaped to provide a ramp elevating the panel members 22 onto a supporting wire 56 until reaching and passing the block 54 where the panel member 22 is caused to fall down. The blocks 52 and 54 and wire 56 are operably mounted to the housing 26 in a manner to avoid interference with pins 24. By so providing, the flow path P is substantially maintained within a production zone within the housing 26.

The device 10 is constructed for operation in the northern hemisphere where rotation will be clockwise. It is understood that the inlet 28 and outlet 30 can be moved to the other side of housing 26 to operate in a counterclockwise rotation for southern hemisphere use.

It is contemplated that multiple devices can be employed in tandem. For example, the multiple devices and contain power transfer means for transferring the energy to a power generating unit such as an electric generator, compressor or the like. In a multiple system, the devices would have at least one direct take off pulley or gear (not shown) connecting the devices together either at the top or at the bottom. The shaft of the rotational power transfer device 10 of the present invention can be directly connected to, or attached, by power transfer devices, to a compressor, generator, hydraulic pump, or other form of energy converting devices for further use or other forms of energy converting devices for converting energy from wind or other motion force into usable electric energy, or for providing compressed air for driving existing steam turbines, e.g., to produce electricity in a conventional power station.

In one embodiment of the invention, the rotational power transfer device is employed in an open environment to harness natural wind forces. Typically, the device is employed in commercial and industrial operations to supply electrical power via a power generating unit to such operations. The device can also be used to supply electricity to smaller facilities such as shops and homes.

In accordance with the present invention, a rotational power transfer device 10 employed in the above specific embodiments, as well as embodiments not particularly specified, can be utilized to pump gas or air to a reservoir via a wellbore, where the gas or air can be stored in depleted reservoir until needed. Presently, there are numerous depleted oil wells which could serve as reservoirs to receive the gaseous materials. The wells would be sealed until a need arises to tap the energy of the stored gas or air.

Still another embodiment is provided and is indicated by the numeral 100. The vertical turbine 100 described herein is a vertically disposed vertical turbine. The turbine 100 includes a rotationally driven electric generator 1 12(or air compressor), i.e., a power maker. The generator 112 (or air compressor) is operably connected to a rotor drive shaft 114 upon which rotation thereof causes rotation of the electrical producing components of the generator 112 (or air compressor) thereby producing electricity therefrom (or compressed air for driving existing steam turbines for example to produce electricity in a conventional power station).

Turning now to the vertical turbine 110, there are a plurality of arcuate panel members 116 each of which preferably having a convex surface 118 (the leading surface) and concave surface 119 (the trailing surface) which extending lengthwise therethrough. The panel members 116 can be equidistantly spaced from one another as well as laterally equidistantly spaced from the shaft 114 preferably in an annular arrangement. The panel members 116 described herein can be made of a rigid or semi-rigid material. The panel members 116 are connected to the rotor drive shaft 114 by way of annular plates 120A and 120B which are axially spaced from one another and fixably connect to the rotor drive shaft 114 via the respective hubs 122a and 122b, respectively.

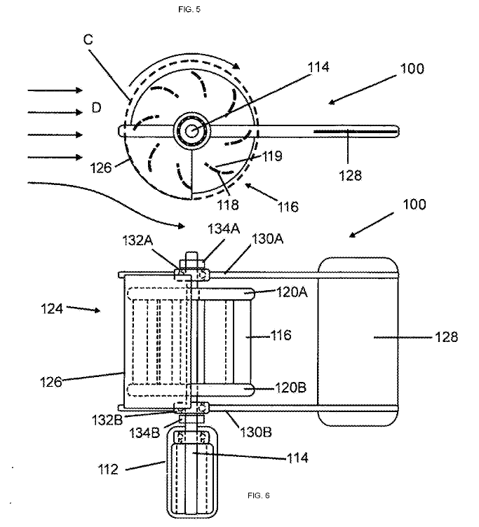

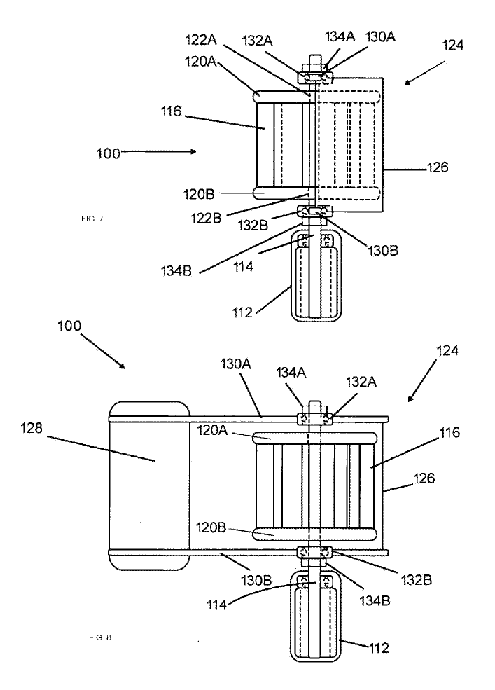

A shroud 124 is provided and includes an arcuate panel 126 which can preferably span about a quarter ways around a circumferential area C defined by the rotational area of the panel member 116 and/or connected plates 120A, 120B. A tail 128 is interconnected to the panel 126 by way of supports 130A and 130B. The supports 130A and 130B include a low friction race bearing set 132A and 132B, respectively, fixed thereto which serve to permit the supports 130A and 130B to freely rotate about shaft 114. The race bearing sets 132A and 132B are preferably spaced from the annular plates 120A and 120B and hubs 122A and 122B as seen in FIGS. 6-8. Also, retaining bearing collars 134A and 134B can be fixably mounted to the shaft 114 to retain and provide low friction bearing surfaces for the race bearing sets 134A and 134B and in turn supports 130A and 130B.

As seen in FIG. 5, regardless of the prevailing air direction D, the tail 128 will be forced in alignment with the air direction D. The supports 130A and 130B are sufficiently long enough so that the tail 128 can be disposed rearwardly enough from the panel 126 and panel members 116 to serve this purpose. Wind is captured by the panel members 116 as they are exposed and unshielded by the shroud 124.

It is recognized that a number of turbines 100 can be stacked on one or more drive shafts and/or side by side relation. Also, the invention recognizes that a number of a gear drive train mechanism can be employed with the turbine 100 of the invention. The vertical turbine 100 can be mounted in an offshore capacity, on top of buildings in areas in which there exist a significant prevailing wind. For example, a support structure can be suitably anchored to the ocean floor and suitable electrical line (or air line) ran to the shore line to a power storage/supply/conversion facility. The vertical turbine 100 can be located in prevailing winds and can move in any direction. The vertical turbine can mounted on a building to supply power thereto.

It is also contemplated that the vertical turbine 100 can employ self regulating equipment such as that known in the art which use a self-regulation baffle which can connect about the shaft 114 and is normally biased by a spring to remain in an open position wherein air flow is permitted in a manner previously described. As the rotational speed exceeds a predetermined amount, the force constant of the spring is overcome and the baffle rotates to closed position, thus blocking air flow about the panel members 16. This provides safety mechanism in times of extreme wind speed.

Although not shown, it is recognized that the generator 112 can be hingedly or universally joint connected to the shaft 114. In this way, the turbine 110 is able to operate safely in varying wind conditions and directions where panel members 116 and shroud 124 move from a vertically disposed position toward a generally horizontal position during a severe wind condition. A transducer/battery can be provided to convert and store energy.

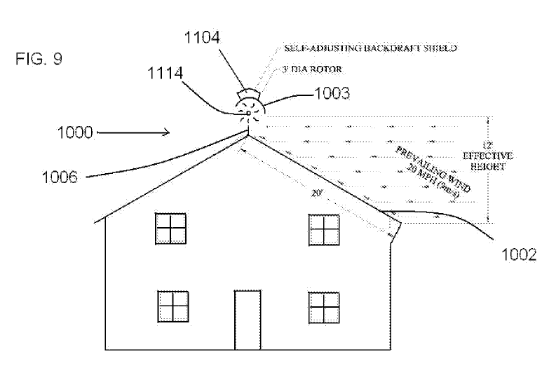

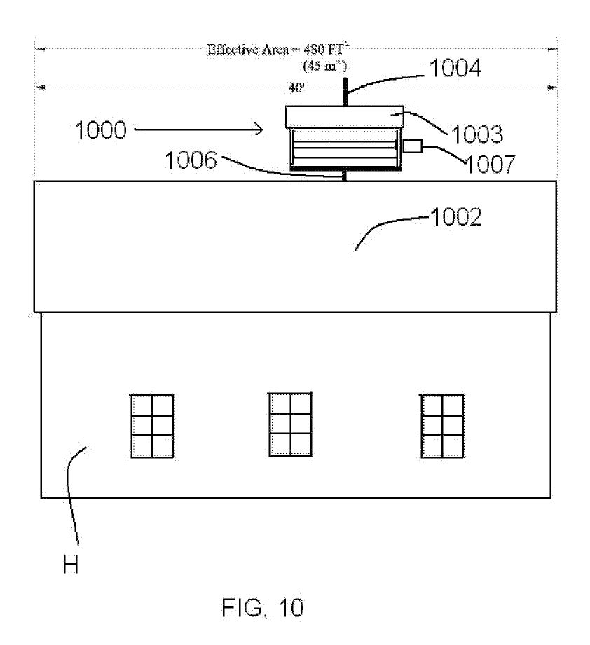

Still another embodiment is envisioned in FIG. 9 and FIG. 10. Here, the turbine 1000 is disposed in a manner such that rotation occurs about a horizontal shaft 1114. The advantage here is that the roof 1002 of the house H becomes part of the wind collection system. A shroud 1003 can include a tail 1004 to serve to cause rotation of the turbine 1000 on a rotatably mounted support shaft 1006 which is connected to the house H. In this embodiment, a generator 1007 is operably connected to the shaft 1114 and can be operably connected to a power storage device and inverter/transformer in order to accomplish the invention. The support shaft 1006 can include an actuating mechanism to move the turbine 1000 vertically, tilting and optionally aid in rotational movement if needed. In this way, the turbine 1000 can be disposed and oriented in an x, y, z manner to maximize the wind collection and performance of the turbine 1000.

As used herein the term “vertical” is defined as a position generally normal to the earth's surface along the lines of the earth's gravitational forces. “Vertical turbine” includes, but is not limited to, cavity surfaces as shown and described herein which are disposed on the vertical rotor drive shaft and has cavity members which generally rotate along a horizontal plane relative to the vertical position and gravitational forces stated.

The above described embodiments are set forth by way of drawings and discussion and are not for the purpose of limiting the present invention. It will be readily apparent to those persons skilled in the art that obvious modification, derivations and variations can be made to the embodiments without departing from the scope of the invention. Accordingly, the claims appended hereto should be read in their full scope including any such modifications, derivations and variations.

What is claimed is:

1. A rotational power transfer device comprising:
a rotatable shaft having a first end and a second end;
an annular member concentrically fixed about a drive shaft;
a plurality of arm structures attached to and positioned equally around said annular member, said plurality of arm structures extending radially outward from an upper portion of said annular member;
a plurality of pin structures attached to and positioned equally around said annular member, said plurality of pin structures extending radially outward from a lower portion of said annular member;
a plurality of panel members, wherein each panel member of said plurality of panel members is hingedly connected to a corresponding arm structure such that said panel member hangs downwardly from said corresponding arm structure;
a housing rotatably disposed on said shaft about said annular member, said panels, said arm structures, said pin structures, said housing having an inlet and an outlet and having a fin formed thereon to direct said inlet into a prevailing fluid force, and wherein a flow path is formed through said housing between said inlet and said outlet; and
wherein said panel members extend below said pin structures such that each pin structure of said plurality of pin structures is oriented in such a manner that said panel members are prevented from swinging moving in said flow path and are freely swinging when out of said flow path; and wherein
said shaft is operably disposed in a position transverse to said flow path having said first end rotatably connected to said housing and a second end rotatably connected to said housing; and
energy converting means attached to said shaft of said device for converting energy provided thereby to electricity.

2. The device of claim 1, wherein said device includes an equal number of arm structures, pin structures and panel structures.

3. The device of claim 1, which includes means for substantially maintaining said flow path through a production zone of said housing.

4. The device of claim 1, wherein said energy converting means is a generator or a compressor.

5. The device of claim 1, further comprising an outer ring attached to a distal end of each of said plurality of arm structures to stabilize and support said plurality of arm structures.

6. The device of claim 1, further comprising converging walls about said inlet and diverging walls about said outlet.

7. A vertical turbine, comprising:
a rotatably driven power maker,
a generally vertically disposed drive shaft operably connected to said power maker,
a first panel member connected to the shaft such that said first panel member is laterally disposed from said drive shaft in a fixed spaced relation therefrom,
a second panel member connected to said shaft such that said second panel member is laterally disposed from said drive shaft in a fixed spaced relation therefrom,
wherein said panel members rotate about said vertical shaft; and
a generally vertically disposed shroud extending partially about said panel members and is connected to a tail which turns said shroud into a prevailing fluid flow so that said shroud covers at least a portion of said panel members which, but for said shroud, would fight prevailing fluid flow during rotation and wherein said panel members rotate about said normally vertically disposed drive shaft with respect to a ground surface.

8. The vertical turbine of claim 7, wherein said panel members include an arcuate surface extending lengthwise.

9. The vertical turbine of claim 8, which includes a plurality of panel members spatially arranged in a generally annular manner.

10. The vertical turbine of claim 7, which includes support members connecting to ends of said panel members to said drive shaft.

11. The vertical turbine of claim 10, wherein said support members are annular.

12. The vertical turbine of claim 7, wherein said shaft includes a joint to enable pivoting of said turbine.

13. The vertical turbine of claim 7, wherein said power maker is an electric generator.

14. The vertical turbine of claim 7, wherein said power maker is an air compressor.

15. A wind powered energy generation system, which includes:
a roof top of a building;
a turbine having a rotatably driven power maker, a drive shaft operably connected to said power maker and generally horizontally disposed with respect to said roof top, a first panel member connected to the shaft such that said first panel member is laterally disposed from said drive shaft in a fixed spaced relation therefrom, a second panel member connected to said shaft such that said second panel member is laterally disposed from said drive shaft in a fixed spaced relation therefrom, wherein said panel members rotate about said shaft without interference with said roof top and a shroud extending partially about said panel members and connected to a tail which turns said shroud into a prevailing wind so that said shroud covers at least a portion of said panel members which, but for said shroud, would fight prevailing wind during rotation.

16. The wind powered energy generation system of claim 15, wherein said panel members include an arcuate surface extending lengthwise.

17. The wind powered energy generation system of claim 16, which includes a plurality of panel members spatially arranged in a generally annular manner.

18. The wind powered energy generation system of claim 15, which includes an actuating support connecting said turbine to said roof top.

19. The wind powered energy generation system of claim 15, wherein said power maker is an electric generator.

20. The wind powered energy generation system of claim 15, wherein said power maker is an air compressor.
